(19) United States
(12) Patent Application Publication
(10) Pub. No.: US 2024/0403975 A1
(43) Pub. Date: Dec. 5, 2024

(54) ELECTRIC VEHICLE USERS NETWORK SYSTEM

(71) Applicant: FLEX E POWER (SINAGAPORE) PTE LTD, Singapore (SG)

(72) Inventors: Brian Fergus MOONEY, Singapore (SG); Huiru YANG, Singapore (SG)

(21) Appl. No.: 18/566,226

(22) PCT Filed: Jun. 22, 2021
(86) PCT No.: PCT/SG2021/050361

§ 371 Date: Dec. 1, 2023

(51) Int. Cl. G06Q 50/00; G06Q 30/0601; H04W 4/44

(52) U.S. Cl. CPC G06Q 50/01; G06Q 30/0601; H04W 4/44

(57) ABSTRACT

An electric vehicle (EV) user network system (100) having a dedicated server (110) and a cloud server (120) for connecting EV owners and users, EV charging stations and EV charging networks, and EV related businesses, comprising an EV Power Grid of charging stations and charging network (20); a One-Stop Shop connecting all EV related businesses in the network (40); a technical support & services network (70), and an Account for each user (50) connecting the user to the EV Power Grid, One Stop Shop and the technical support & services network; all the users and EV related businesses connected and communicating with each other in a community network for dissemination and education of EVs and EV related matters (60).

The EV user through an User Account is connected to the EV Power Grid, the One-Stop Shop (40), EV related businesses, technical support & services network and other users in the network through the community network (60), in real-time. The EV User is able to have real-time access using a mobile phone or personal computer or the like to obtain goods and services with EV related service providers and businesses. Each User draws down points for usage of services in a subscription base model. Services include charging of EV and purchase of goods and services from EV related businesses and provision of technical support and other services provided by the EV user network (100).

A method of using the user network and system to select a charging station is also proposed. A Mobile Application using the method and system is also proposed.

### FIELD OF INVENTION

The present invention relates to an Electric Vehicle Users Network System, which connect Electric Vehicle Owners, a plurality of Electric Vehicle charging stations and Electric Vehicle charging networks and Businesses dealing with Electric Vehicle related goods and services to interact, carry out transactions, communicate and exchange information on Electric vehicle related matters, for the building up of a community of Electric Vehicle Users.

### BACKGROUND

Electric Vehicles (“EVs”) are becoming popular with motorists. Although the take up rate of EVs is still slow, it is expected EVs would come into main stream of motoring soon. At present, EVs lack sufficient infrastructure such as charging stations and repair workshops able to handle EVs.

At the same time, the majority of motorists lack knowledge on how EVs work e.g. no clutch, fewer moving parts. EVs face some disadvantages:
Electric cars have a shorter range than gas-powered cars.
Recharging the battery takes time.
It can sometimes be difficult to find a charging station.
There aren't as many model options.

EVs run on electrically powered engines, and hence there is no need to lubricate the engines, anything related to the combustion engine or a long list of regular maintenance tasks that are usually associated with a gasoline=powered or internal combustion engine. With the adoption of EVs, expensive engine works is going to be a thing of the past. Therefore, the maintenance cost of EVs would come down and the period between maintenance of the vehicle and engine longer. As such there is no need to send it to the workshop for servicing so often when compared to a petrol-powered or diesel powered car.

EVs have the simplest driving method. EVs come with a transmission comprising of only one really long gear and also don't suffer from the stalling problem as petrol cars do. This effectively eliminates the need to add a clutch mechanism to prevent that from happening. Therefore, EVs are operated with just the accelerator pedal, brake pedal and steering wheel. EV Owners would have to re-educate themselves on operations and use of EVs.

Another really useful feature of EVs is regenerative braking. In normal cars, the braking process is a total wastage of kinetic energy that gets released as frictional heat. However, in an electric vehicle, the same energy is used to charge the batteries.

A main disadvantage of EVs is their limitation of range before recharging and speed. Most EVs have a range of about 200 to 400 km before being required to be recharged again. EVs are not used for long distance journeys as of now, although this is expected to improve in the future.

Another disadvantage of EVs is an EV takes about 4-6 hours and sometimes even a day to get fully charged compared to taking a couple of minutes to fuel a gasoline-powered or diesel-powered car, EVs also need dedicated power stations as the time taken to recharge them is quite long. Thus, the time investment and necessary planning to search for a charging station is a major disadvantage at this point in time.

Most Governments are encouraging motorists to use EVs. The trend of EVs becoming main stream is likely to increase in the next few years. However there are perceived gaps in the EV community in terms of information for users and data on EVs and Charging Stations.

The end result is the EV users may not realise the full benefit of EVs until the gaps in information and data are filled, enabling EV users to get real-time information and data on all types of EV, and data on charging points to enable EV users to make decisions on charging, maintenance and operation of EVs. While there is an eco-system for EV users and EV businesses, the eco-system is fragmented. As such, there is no real community of EV users and EV businesses, whereby each party may reap benefits from being within such a Community.

### DISCUSSION OF PRIOR ART

The prior art discussion herein is to provide background information to the development of an eco-system or community of EV users and service providers.

U.S. Pat. No. 7,272,496 82 filed on Jun. 18, 2003 describes a vehicle communication network includes a plurality of network elements and a plurality of communication links communicatively coupling the network elements in a point-to-point configuration. At least a portion of the plurality of communication links are specified in accordance with a shared-access bus protocol. The plurality of communication links are arranged to communicate data packets between the network elements, and data packets are modified for transport via the plurality of communication links.

US Publication No. 2009/0082957 (filed on Sep. 19, 2008) describes an electric vehicle that includes an electric motor that drives one or more wheels of the vehicle and is powered by a battery. The electric vehicle determines a status of a battery of the vehicle and a geographic location of the vehicle. The electric vehicle then identifies at least one battery service station that the vehicle can reach based on the charge status of the battery of the vehicle and the geographic location of the vehicle. The electric vehicle displays the at least one battery service station to a user of the vehicle.

US Publication No. 2011/0071932 filed on Nov. 24, 2010) describes an electric vehicle network is provided. The electric vehicle network includes a plurality of battery service stations and a service provider. The battery service stations are configured to service the batteries of a plurality of electric vehicles, and the electric vehicles are operated by a plurality of users. Battery service stations are configured to recharge batteries, replace spent batteries, or both. The service provider communicates with the battery service stations to facilitate servicing of the electric vehicles as the service stations based on subscription plans associated with the users. A plurality of subscription plan options is provided to the users.

US Publication No. 2011/0202476 A1 filed on Feb. 14, 2011 describes a method for recharging an electric vehicle in a recharging station of a network of geographically distributed recharging stations. The method includes: communicating availability of a recharging station to a control centre of the network; trans-mitting a recharge request from an onboard unit of the electric vehicle via communication devices of a road toll system to the control centre; assigning the onboard unit to an available recharging station in the control centre; notifying the onboard unit of the assigned recharging station via the communication devices of the road toll system and notifying the recharging station of the onboard unit; and activating the recharging station to recharge the electric vehicle, when the assigned onboard unit is detected therein. The recharging in the recharging station is monitored and an image of the vehicle is recorded in the recharging station in an event of an interrup-tion, interference or deviation in the recharging process from a given course.

US Publication No. 2017/0169648 (filed on Feb. 28, 2017) describes a computer implemented method for detecting, by a computer of a charging unit (CU), a connection of a charging connector of the CU to a vehicle charge port of an electric vehicle (EV). The detecting of the connection includes processing a data exchange between electronics of the EV and the computer of the CU. The method includes receiving, by the computer of the CU, charge status of the EV while the charging connector is connected to the CU. The received charge status of the EV changes as charge is provided from the CU to a battery of the EV. The method includes sending a notification by server to a user account that was used to obtain charge for the EV at the CU. The notification provides data for a graphical user interface that shows the charge status of the EV. The method includes receiving instructions from a device associated with the user account, to make payment of a fee or receive a fee charge, to instruct the CU to indicate an in progress or in-use state even when the EV is at a full level of charge while the EV is occupying the CU and is preventing others from access to the CU that is provided for public use of users with user accounts. The method includes sending data by the server to the computer of the CU to display an in progress or in-use state, wherein the server communicates over the internet with the device.

US Publication No. 2017/0197678 (filed on Jan. 11, 2017) describes methods for utilization of shared vehicles that are structurally and reversibly reconfigurable to suit requests for particular vehicle configurations. Vehicle use is monitored for plural vehicles shared among multiple users/uses. In response to a first request for a first particular configuration of a vehicle, a first vehicle is selected/provided in the first particular configuration having a predetermined first feature set, the first feature set being automatically set based on the first vehicle being placed in the first particular configuration. In response to a second use request for a second particular configuration of a vehicle different from the first particular configuration, the first vehicle is selected/provided in the second particular configuration having a predetermined sec-ond feature set, the second feature set being automatically set at the first vehicle based on the first vehicle being placed in the second particular configuration, the first feature set being different from the second feature set.

It seems EV motorists do not seem to have much support from other EV users in terms of information on EVs and related products and services. This may be due to novelty of EVs and possibly that EVs have not become mainstream mode of vehicle transportation for motorists.

The inventors note that EV users face ever-growing difficulty in navigating their way through the new challenges and rewards of being an EV owner or EV user. There do not seem to be an eco-system consisting of a community of EV users, the EV users connected with each other, with service providers and other interested businesses, all electronically linked to enable information on EVs to be disseminated for the benefit and use of EV users. Through this community, EV users would have all their daily needs in using and maintaining their EVs addressed by other EV users and EV service providers. Such a community would remove the fear of EV ownership and the unknown, through provision of information and support thus contributing to the growth of EV use.

In addition, the inventors realise synergies may be obtained for EV owners from accessing and using multiple charging networks (operated by different EV charging systems/networks) through cross-use and sharing of charging stations, contributing to more efficient search and utilization of charging stations.

EVs operate very differently from petrol or diesel powered motor vehicles and EV users would require new knowledge on how EV works differently so as to be safe on the roads.

The creation of a community of EV users and service providers would ensure the educational aspect of new EV owners are met, especially those owners who may not be technically minded.

What is needed is a one-stop network which offers information for all EV users and EV operational needs. Such information may range from advice on how EVs work differently from gas and diesel powered cars to information on how to handle breakdowns of EVs.

It would be advantageous if EV owners are able to use any charging station which is available for charging irrespective whether it is individually managed or managed by a building owner or a EV Network operator or even a petrol station, so long as these are part of a EV Power Grid. Such a EV Power Grid would ensure optimization of EV Charging resources and at the same time offers more flexibility to the EV Owner in terms of choice of charging location and time of charging.

### SUMMARY OF INVENTION

A first object of the invention is an electric vehicle (EV) user network system having a dedicated server and a cloud server for connecting EV owners and users, EV charging stations and EV charging networks, and EV related businesses, comprising:
(i) an EV Power Grid of charging stations and charging network;
(ii) a One-Stop Shop connecting all EV related businesses in the network;
(iii) a technical support & services network;
(iv) an Account for each user connecting the user to the EV Power Grid; One Stop Shop and the technical support & services network; and
(v) all the users and EV related businesses connected and communicating with each other in a community network for dissemination and education of EVs and EV related matters;
   wherein the EV user network system connects the EV Power Grid of charging stations and charging network, the One-Stop Shop, all Account Users, EV related businesses connected and communicating through the community network, and to the technical support and services network in real-time, enabling real-time access using a mobile phone or personal computer or the like, and
   wherein the EV user network system provides a number of services to EV owners or users as members of the EV user network, each member draws down points for usage of services in a subscription base model, services including charging for charging of EV and purchase of goods and services from EV related businesses and provision of technical support and other services provided by the EV user network.

Preferably the support from the EV User Network System includes
(i) price comparisons on available charges;
(ii) topping up account of the members;
(iii) providing services that no other charge point operators provide together with a host of additional benefits;
(iv) establishing a network for all members in the EV user network as a community;
(v) incorporating all EV related businesses offering goods and services related to EVs; and providing a point system or rewards scheme based on usage, purchases of goods and services from within the EV user network system.

Preferably the host of additional benefits in the EV User Network System include (i) mobile charge call out service, (ii) recover my car service, (iii) drive me home service, and my mechanic online.

Preferably, the services and benefits are provided around the clock.

Preferably, the members of the community are able to view their respective account designated as Flex e Account.

Preferably, the goods and services offered by EV businesses include:
(i) purchase of EV insurance;
(ii) car loans and financing;
(iii) car servicing and repairing;
(iv) home charging units and installation;
(v) battery rental;
(vi) voucher rewards;
(vii) members points redemption, and
(viii) charity support such as giving back to communities or other charitable institutions.

Preferably, the EV charging network provides the function of (i) locating and booking an EV charger, (ii) EV charging price comparison, and (iii) trip planning with EV charging features in mind, including available socket type, compatibility of connector and charging output.

Preferably, the technical support & services network (70) offers services include:
(i) technical support/advice via live chat;
(ii) mobile charge call-out service;
(iii) car recovery service; and
(iv) drive-me-home service.

Preferably, the one stop shop connects the users to EV related businesses to obtain goods and services including:
(i) managing car insurance, loans, financing and the like;
(ii) arranging for EV maintenance, repair, battery rental;
(iii) arranging for home charging unit installation and repairs; and
(iv) purchasing EV-related items with price comparisons.

Preferably, the Account of each User allow points to be earned for the Account by the EV User:
(i) charging each EV or obtaining goods and services from any EV related business;
(ii) using points to get shopping discounts, partner rewards, or free goods and services;
(iii) reviewing past transactions; and
(iv) reviewing membership details and account information.

Preferably, the members in the community network (60) may (i) communicate with each other in chat rooms about EVs, (ii) access EV related news and updates, and (iii) access EV reviews.

Preferably, access to EV related news and updates and access to use of EV charging networks and charging points are by way of a Mobile Phone app.

Preferably, access to EV related news and updates and access to use of EV charging networks and charging points are by way of a Personal Computer or a Laptop or Tablet.

Preferably, access to the EV related news and updates and access to use of EV charging networks and charging points is by any electronic computing device with Internet access installed in an EV.

A second object of the Invention is a method to connect an EV User to an electric vehicle (EV) user network system having a dedicated server and a cloud server with EV owners and users, EV charging stations and EV charging networks, and EV related businesses, using a Mobile App to search for a charging point to charge an EV, the method comprising the steps of:
(i) logging in to the EV user Account with user ID and password to access to the EV user network;
(ii) clicking onto “LOCATE & CHARGE” function in the Mobile App;
(iii) selecting a location of all EV chargers indicated by the Mobile App in step (ii);
(iv) carrying out price comparison for all EV chargers in the said location;
(v) using “Book My Charge” function to reserve a time slot for charging; and
(vi) employing “Plan My Trip” function to drive to the selected charging location.

Preferably, the method to connect an EV user to an EV User network using a Mobile App to search for a charging point to charge an EV includes EV chargers operated by Petrol Stations or by EV sharing operators or by an independent operator of EV chargers as part of a EV Power Grid in the EV User Network System.

Preferably, all communications on charging by the EV user is linked to a charging Network provider via the EV Power Grid in the EV user network system, and the changing network provider will send a message to the EV user that the charging process is completed.

Preferably, a message is sent to the EV owner by the charging network provider upon the completion of the charging process, and the EV owner drives away the EV and logs out of the Charging network and EV Power Grid.

Preferably, the EV user can check an Account of the EV user on the credit balance in the Account to ensure the credit balance of the Account is correct, and to perform a “top up” in the Account.

Preferably, an electronic bank transfer from a bank account of the EV User is made to perform the “top-up” to the Account of the User by using the Mobile Phone.

Preferably, a Personal Computer and/or a Tablet or any electronic computing device installed in the EV is used by the EV user to perform the method to search for a charging point for the EV.

More advantageously, the EV user network system, further comprises
(vi) a single authorisation and authentication allowing the user to access data and provide specific rights of access to different parties in the EV user network.

More advantageously, the electric vehicle (EV) user network system, further comprises
(vii) a plurality of interface modules enabling data to be exchanged across various operating platforms and systems.

More advantageously, the electric vehicle (EV) user network system further comprises an EV Businesses Information Portal which allows EV users to receive notification on new products, reference information on the new products and all goods available for sales and promotions from EV businesses.

More advantageously, the electric vehicle (EV) user network system, further comprises an EV owners Information portal which allows the EV user to exchange messages and chat with each other through the EV owner information portal, thus, enabling all EV owners to receive notification and updates on EV related matters.

Preferably, the EV Businesses Information Portal in the EV user network system provides notifications on new products include links to a plurality of EV models.

More advantageously the EV user network system further comprises an enterprise network which includes a plurality of service providers of EV Service/Repair/Maintenance, bank/financial institutions, and EV-related Businesses.

Preferably, the enterprise network provides services including 24-hour emergency mobile call out, emergency charge service, drive me home service, and 24-hour car recovery service.

More advantageously, the electric vehicle (EV) user network system has a system manager/operator to manages and operate the EV user network and is responsible for smooth management of all EV user and EV related businesses in the system in the network.

Preferably, the system manager/operator prepares and circulate different circulars and newsletters for different groups with different interests within the EV user network.

Another object of the electric vehicle (EV) user network is for the system manager/operator to open an Account (50) when an EV User joins as a member on a subscription based model so that the EV User could enjoy membership privileges, including access to the EV User Network to:
(i) obtain points by charging or making purchases for goods and services from EV related businesses and for charging the EV;
(ii) use the points to get shop discounts, partner rewards or free goods and services;
(iii) review past transactions by the EV user; and
(iv) review membership details and information.

A further object of the electric vehicle (EV) user network system is for the system manager/operator to open an Account when an EV related business joins the EV User Network as a business partner member in order to offer EV related goods and services to other users in the User Network, including:
(i) offer goods and services to and receive payment from Users in the Users Network including services for charging the EV;
(ii) offer discounts, partner rewards or free goods and services;
(iii) reviews transactions by the EV related businesses; and
(iv) circulate EV related information to EV users.

A final object of the electric vehicle (EV) user network system (100) is to enable the EV user to access an On-line learning system in the User Network System to learn about EVs, reviews on test drives of EVs and information on EV batteries.

### BRIEF DESCRIPTION OF THE DIAGRAMS

For a better understanding of the invention, its advantages, and the objects attained by its use, reference should now be made to the accompanying drawings. The accompanying drawings illustrate one or more embodiments of the invention and together with the description herein, serve to explain the workings and principles of the invention. The diagrams by no means restrict the invention to only what is shown.

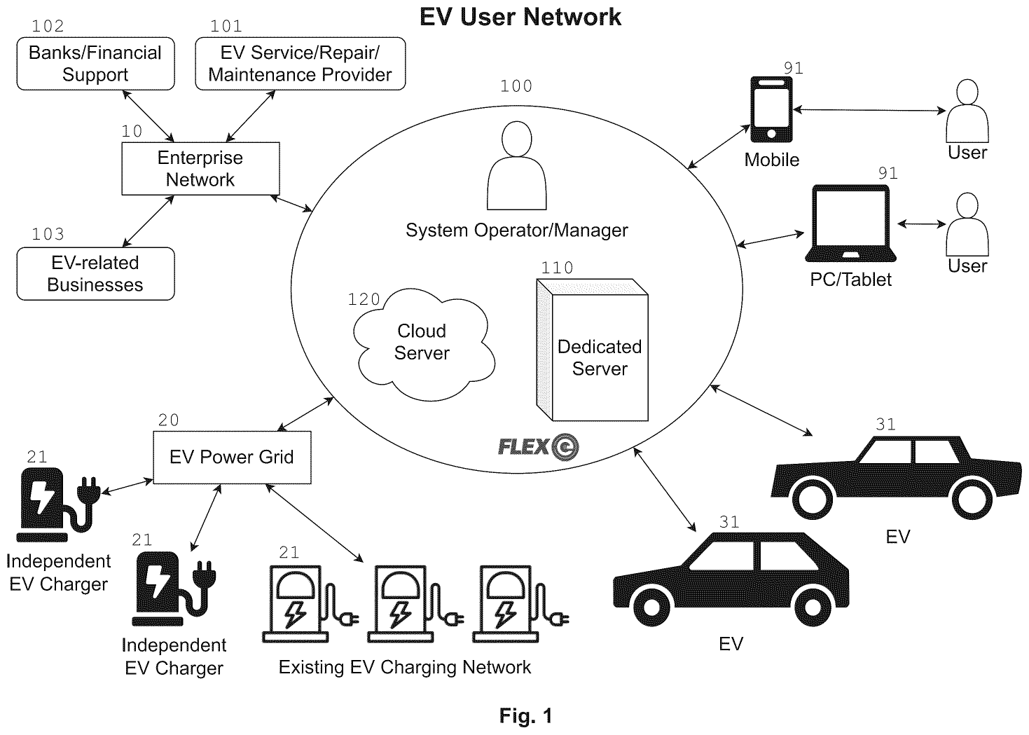

FIG. 1 is an overview of the parties involved in a community of EV users and service providers forming this eco-system.

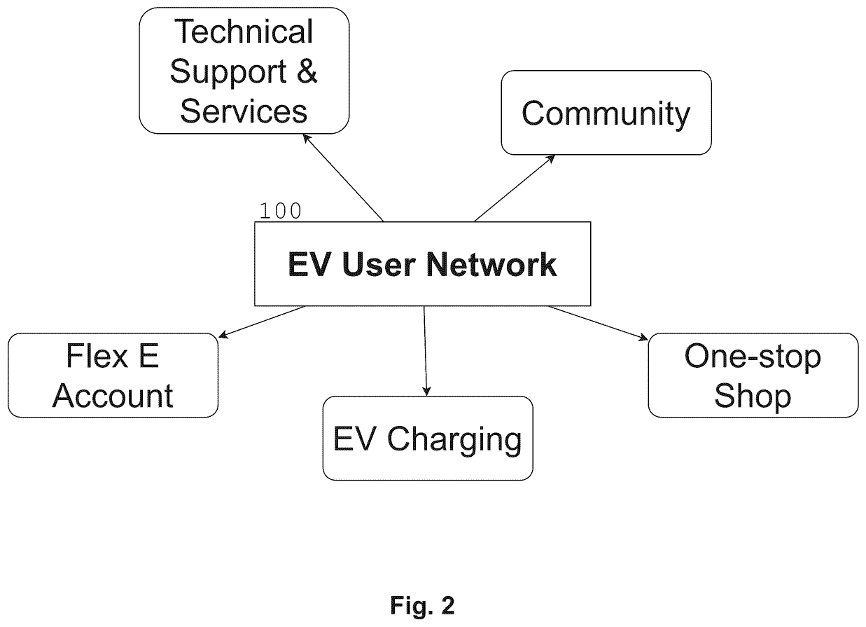

FIG. 2 is an overview of the EV Users Network System which have these main Modules/Sub-systems (not exhaustive).

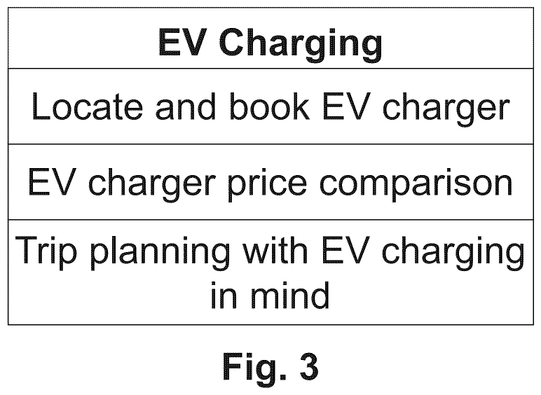

FIG. 3 is a list of features for an EV Network User looking for “EV Charging”.

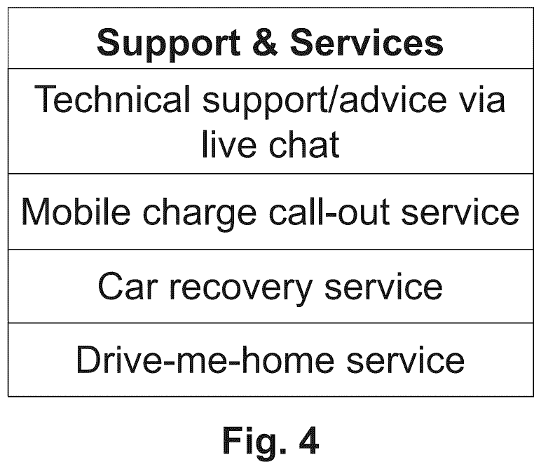

FIG. 4 is a list of features for an EV Network User looking for “Support & Services”.

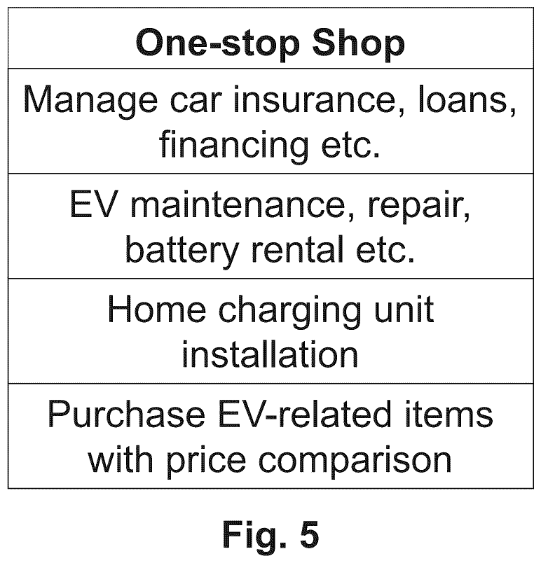

FIG. 5 is a list of features for an EV Network User looking for “One Stop Shop”.

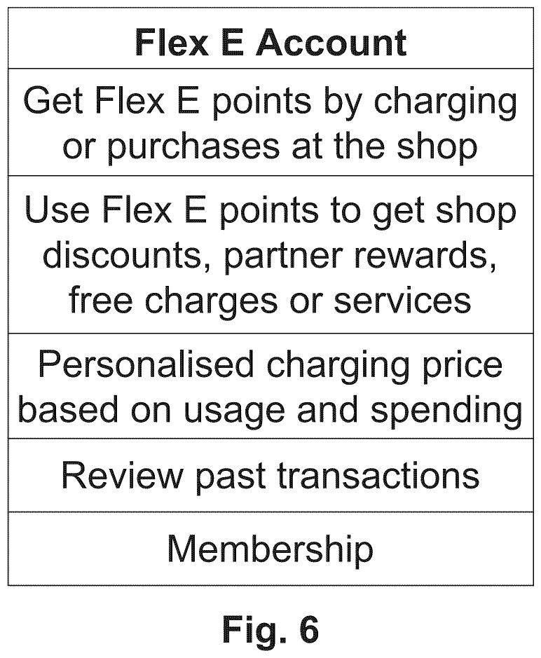

FIG. 6 is a list of features of an account of an EV User.

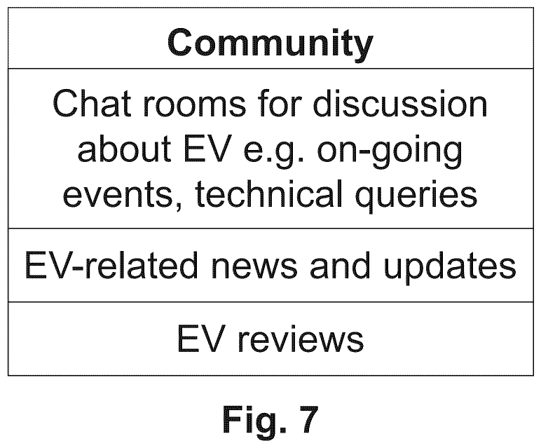

FIG. 7 is a list of features linking an EV User to the members in the Community.

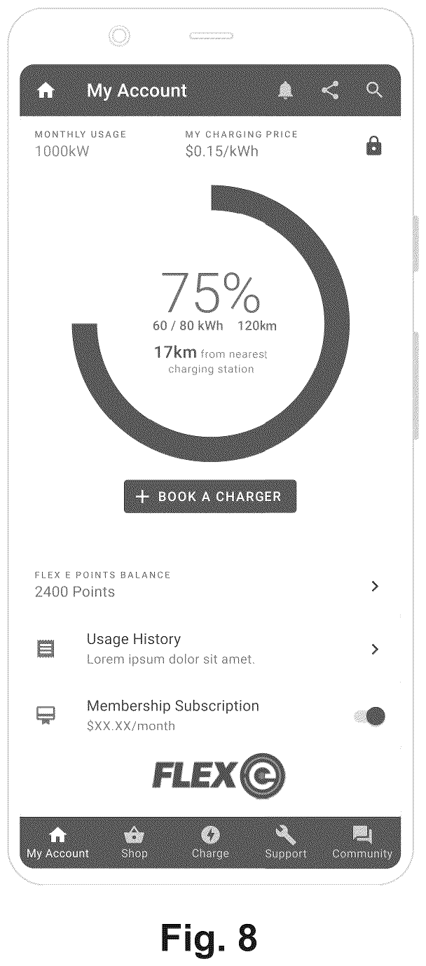

FIG. 8 is an illustration of the Main page of the Mobile App showing the member's Main Menu or Dashboard and features/functions in the App accessible by the member.

### DETAILED DESCRIPTION OF EMBODIMENTS OF THE INVENTION

The terms or words used in the description and the claims of the present invention are not to be construed limitedly as having typical or dictionary meanings, but should be interpreted as having meanings and concepts of the invention in keeping with the spirit of the invention based on the principle that the inventors can appropriately define the terms in order to describe the invention in the best way.

“EV owner”—a person owning and using an Electric Vehicle (31). This term may include a person who books and uses an EV through an EV Sharing Scheme. For the purpose of describing the invention, the term “EV Owner” and “EV User” is used interchangeably since EV owners would include EV users, who would lease EVs on a time sharing or participate in other car sharing schemes which include EVs.

“Charging Point” (21)—a power source with EV Charger (21) to charge an EV. The Charging Point could be located in an Office Building or a Condominium or part of a series of Charging Points operated by EV Sharing Operators. A number of Charging Points could be even installed on the side of roads or car parks, for use by EV motorists. The Charging Point could be a charger with 7 kW-22 kW which would give an EV a “fast” charge-usually in around 4 to 6 hours or even a 50 kW-120 kW charger (classified as a “rapid charger”) giving a full charge in about an hour and having connection to the Internet (“smart charger”).

“EV Charging networks” (21)—A plurality of charging points (with different kW ranges) managed by an Charge Point Operator where charging points could be at an office building or condominium, or managed by a petrol chain or a network of charging stations operated by a EV sharing scheme or a number of charging points along the roads or car parks managed by independent operators. A smart charger would enable the Charging Points to be connected to an EV Power Grid (20) in the EV Users Network System.

“EV Power Grid” (20)—the consolidation and connection of EV charging networks (21) whether operated by independent operators or otherwise to form the EV Users Network System (100). By using smart chargers, each individual Charging Point would be connected to the EV Users Network System. By bringing all EV charging stations and networks together, EV owners have a better choice on which charging point to select when they need to charge their EV. The EV Power Grid would ensure optimal efficiency of charging points and EV users obtain the best prices for charging their EVs.

“EV related businesses” (103)—Businesses providing services and goods to EV Users and who are members of the EV Users Network.

“EV Users Network”—a Community of EV Users and EV related businesses, all of whom have an account with the EV Users Network System (100) and able to communicate and transact on EV related services and goods through the EV Users Network System. The EV Users Network would bring a number of fragmented groups into a group where information and knowledge flows freely and synergies are reaped.

“EV Users Network System” (100)—the Computer systems, including dedicated servers (110) and Cloud based servers (10) connecting all the users and their electronic devices (91) in the EV Users network. The term “EV Users Network and System” is also used herein interchangeably to refer to the Computer systems, including dedicated servers and Cloud based servers, used for the EV Users Network.

“EV Users Network and System Operator”—the System Operator and Manager of the entire EV Users Network System (100) or EV Users Network and System.

The invention proposes to bring all EV users, EV charging operators and EV related businesses (103) in a network using the EV User Network and System to provide real-time information on:
status of battery in an EV
status of a Charging Point in a Charging Network (part of EV Power Grid)
status and timing for servicing of an EV
status of a member's account and activities of a EV User member
EV related services and products offered within the EV User network

The EV User network aims to overcome the challenges of an EV owner for information on:
Location and availability of chargers
Time and price comparisons of EV Charging from different operators of
EV charging networks/stations within the EV Power Grid
Costs and type of services for service/repair and maintenance of an EV
Information and advice on EV related operational issues.

The creation of a community of EV users and service providers would ensure the educational aspect of new EV owners are met, especially those owners who may not be technically minded. The proposed EV Users network is an one-stop network which offers information for all EV users and EV operational needs. Such information may range from advice on how EVs work differently from gas and diesel powered cars to information on how to handle breakdowns of EVs. Network users would be able to obtain real-time information from the EV Users System through a Mobile Phone or Personal Computer or Laptop or a Tablet or even the electronic computer in the EV (91).

FIG. 1 is an overview of the parties involved in a community of EV users, EV Charging Stations (21) (both independent EV Charging Stations as well as EV charging network operators and service providers of EV businesses (103) forming this eco-system. At the present, these parties in the eco-system are operating on their own e.g. an EV owner purchases an EV from a motor vehicle distributor who has been selling petrol or diesel powered motor vehicles. As such, the EV owner may not obtain much help or assistance from the motor vehicle distributor since their experience would be mainly in petrol-powered or diesel powered cars.

A number of charging points (21) may be operated in an office building or shopping mall while an EV sharing operator may also operate another EV network. Petrol stations may also offer EV charging points. Independent EV Charging points also exist. Therefore if EVs become the mainstream mode of transportation in the foreseeable future, these EV charging stations must be managed efficiently for all EVs through an EV Power Grid (20) as part of the EV users Network. The EV Users Network System (100) would enable an EV owner to select which EV charging point/station offers the lowest costs or which charging point is nearest and available within the next hour. Depending on membership status, the EV Owner may even booked a EV Charging point before reaching this Charging Point so that nearby EV owner may not use it before his arrival.

Even before using the EV, the EV owner would have some difficulty buying EV insurance since almost all general insurance companies have little experience with EVs. The EV owner would charge his EV at home or at an EV Charging station operated by a third party operator of charging points (21). The EV owner may not understand the structure and costs of charges for electricity consumed from his home or from EV charging points.

Arising from a survey of present EV eco-system, the inventors found that EV charging infrastructure is not well developed. The EV owner may have to charge his EV at home or from charging stations installed in a few buildings (offices and shopping malls). There are also EV car sharing schemes wherein EVs are parked and charged before the next booking of the EV commences. Petrol companies may also introduce EV charging points in their own petrol stations to cater to the increasing number of EVs. Installation of Charging Points may be easily carried out and without going through much red tape (unlike petrol stations, due to regulations on fire safety and hazardous goods). Since obtaining permits for installation of charging points or charging stations from Governmental Authorities are likely to be easier, unlike installation of petrol stations, there is a trend of independent EV operators installing a few charging points along some streets. The EV Users Network proposes to connect all separate charging networks (however owned or operated) into an EV Power Grid (20) (hereinafter “EV Power Grid”), for more efficient utilization of EV charging resources. The EV Users Network System (100) would monitor the status of all charging points within the System, which are equipped with smart chargers, whether these are installed by independent operations such as offices and shopping malls or other EV network operators. An EV User would be able to check the availability of charging points and the type of charging point e.g. socket type, compatibility of connector and charging output at each location and would be able to compare the charging rates. This would allow the EV owner to select a charging point according to his preferences. When the market for EVs grows bigger, the EV Power Grid would be more efficient in distributing all EVs to EV charging points.

If there is an issue in operating an EV (which operates differently from petrol-powered or diesel powered motors), the EV user or owner would have difficulty finding a workshop with facilities and personnel trained to handle and diagnose EVs. This gap in service providers for servicing and maintenance of EVs is also apparent at the present.

It may be seen that there are gaps in knowledge of EV and their operations and gaps in services within the EV eco-system. There is also no link amongst EV users/owners and amongst EV owners/users with EV service providers in the EV eco-system. As such, these groups are separated not only from each other, but EV users within each group may not have their own sub-community, to share knowledge on a formal basis. While an EV eco-system exist at present and is fragmented, there is no community because there are no links or cross-connections amongst the sub-groups and between individual EV user/owner and EV service providers and other EV related businesses.

The inventive EV user network proposes to bring all EV owners (herein including EV users), EV service providers (103) (such as EV service and repair workshops), EV insurance companies. financing/leasing companies (102), EV charging operators (including independent operators and other EV car leasing operators with charging facilities) into an EV user network which offers real time information on operations of charging points in EV networks and other information. A EV User Network System (100) is proposed to solve the current issues facing EV Users and EV related businesses as described earlier. This EV User Network and System, would also enable sharing of information and knowledge on EVs to enable EV community to obtain benefits and synergies in use of EVs and utilization of EV Charging points and Charging Stations (21).

FIG. 2 is an overview of the EV Users Network and System which have these main Features (not exhaustive) made available to the EV User:
(1) One Stop Shop
(2) User Account (called “Flex E” Account)
(3) Payment and Rewards in User Account
(4) Community
(5) EV Charging
(6) Price Comparison and Locate and Charge
(7) Technical Support & Services

The EV Users Network and System (100) connects all parties through a dedicated server (110) and also allows Cloud computing (120), linking all parties in real-time and enabling real-time access using a mobile phone or Personal Computer or a Tablet or a Lap Top, including any Electronic Device in any EV which functions like a Personal Computer.

The operator of the EV Users Network and System (100) would provide a number off services to EV owners/users as members of this Network. Each member can draw down from in a subscription based model. The usual charges for car charging will apply but receive is additional support for their everyday needs for an annual subscription fee for the following activities:

### Locate & Charge (FIG. 3)

Standard EV Charger location support via the Mobile App but also support on price comparisons on available chargers plus a Book My Charge Time Slot function plus Plan my Trip.

### My Account and Discount (FIG. 6)

Allowing the community members to top up their account in the Users Network System to view their spend and use the Account (called Flex e Account).

### My Support (FIG. 4)

This function provides additional services that no other Charge Point Operators provide. In addition, the EV Users Network System would support users (members) with a host of additional benefits including:
Mobile charge call out service.
Recover my car service.
Drive me home service.
My mechanic online. (live chat available online)

The Operator of the EV Users Network and System provide these services to give peace of mind to EV users (members) so that they never have to worry about being stranded or not being able to ask a question about their EV. Through this EV Users Network System, EV users would be able to get live feedback around the clock.

### My Community (FIG. 7)

The Operator of the EV Users Network and System would bring all participants in the EV User Network into a vibrant and active EV community providing a host of services including:
EV Chat room (Talk to other EV car owners)
Government updates (regional)
EV News and Reviews

### MY Shop (FIG. 5)

This incorporates all things EV giving a shop window to comparing prices and purchasing all EV related items. These include (again not exhaustive), the following:
Purchase of EV Insurance (Preferable community rates)
Car loans and financing
Car servicing and repair
Home charging units and installation
Battery rental (regional)
Voucher rewards
Members Points redemption.
Charity support, giving back to our communities.

### Membership Points

The whole community platform is underpinned by a points system or rewards scheme based on usage of the EV Users Network System (100). Such points are earned on purchase of EV power or even through purchases of goods and services from within the EV Users Community through the EV Users Network System by members. The points can be redeemed through the partners taking part in the EV Users Network System or used to receive free charges or services. The points will be shown in a member's account in a real-time basis. Such management and administration of a points system or rewards scheme is known and its structure would only be discussed briefly herein. The membership structure would also cover a few levels from basic membership to full membership (as a EV User) or as a Business Partner Membership for EV retailers or EV Service Providers.

FIG. 3 is a list of features on EV charging within the EV Power Grid:
Locate and book EV Charger
EV charging price comparison
Trip planning with EV charging in mind

FIG. 4 is a list of support and services offered and through by the Network:
Technical support/advice via live chat
Mobile charge call-out service
Car recovery service
Drive-me-home service

FIG. 5 is a list of features for an EV Network User looking for “One Stop Shop”. The EV User would be able to carry out the following activities/functions:
Manage car insurance, loans, financing etc.
Arrange for EV maintenance, repair, battery rental
Arrange for home charging unit installation and repairs
Purchase EV-related items with price comparisons

FIG. 6 is a list of some features for an EV User with an account:
Get points by charging or making purchases at the retail outlets (part of the EV users Network)
Use points to get shop discounts, partner rewards or even free goods and services
Review past transactions
Review membership details and information

FIG. 7 is a list of some features linking an EV User to the members in the Community:
Participate in chat rooms about EVs
Access EV related news and updates
Access EV reviews

FIG. 8 is an illustration of the Main Menu of the Mobile App showing the member's Main Menu or Dashboard and features/functions in the App accessible by the member.

### Mobile App

Access to information on EVs as well as access to use of EV charging networks and charging points would be mainly through a Mobile Phone app. However access would also be through a Personal Computer or a Laptop or even the on-board computer in the EV (91).

The features of the EV Users Network and System using the Mobile App to interface with the Network System (100), how the Mobile App works and its various functions would be explained with reference to FIG. 8.

The Mobile application interface of EV User Network System would work with multiple mobile phone systems (Android and Apple) as well as in other non-mobile phone software platforms and other types of electronic devices such as tablets and PCs. Since the EV User Network System include individual EV owner/user as well as EV related business (103), the EV User Network System using the Mobile App to interact with the EV User Network System would be suited for either personal use or business use. However each type of user, be it EV Owner or EV Business owner would have their own screen and sub-system.

Each User would have to apply for an account in accordance to their status. For example, a EV retailer would have to open a EV Business Partner Account while an EV owner would have to open a EV User (or Member) account. The procedures for opening an account, including the provision of details of the user or business are known and would not be discussed further herein.

Numerous features on EV Users Network System and Mobile App described herein will be apparent to persons skilled in the art and would not be discussed herein. For example, the Mobile App may have additional functions like the feature of printing reports of all sorts extracting data from the database. Such reports may also be produced electronically, maybe download in various file formats, and even may be e mailed to others (users as well as non-users).

### “LOCATE & CHARGE” Function in the App

The App provides locations of all EV Charger locations with the EV Power Grid (20). The EV owner would also be able to carry out price comparisons on available chargers offered by different EV Charging Operators within the EV Power Grid using the Price Comparison feature in the Mobile App. If the EV owner decides on a EV Charging location, he would use the Book My Charge Time Slot function. In addition the EV Owner would use Plan my Trip feature to drive to the Charging location in the shortest possible time.

Since the EV User Network System (100) has a few category of members, EV Users may be offered priority in selection of a particular Charging Location in accordance to their membership status.

### “My Account and Discount” Function in the App.

The feature allows each member to top up their account, view their spending in a particular period and use their membership e card to make purchases of goods and services and redeem points.

### “MY SUPPORT” Function in the App

This function provides additional services that no other CPO (Charge Point Operators) provide. These features would provide support to EV users in the EV User Network with these benefits including
Mobile charge call out service.
Recover my car service.
Drive me home service.
My mechanic online. (live chat available online)

The services and features in the EV User Network and System would contribute to the establishment of an EV Community, providing peace of mind to EV owners and users so that they never have to worry about being stranded or not being able to ask a question about their EV and would be able to obtain live feedback around the clock. By bringing all operators of EV Charging points, whether independently operated or by petrol stations or owned and managed by EV sharing operators, the EV Power Grid (20) would ensure optimal utilization of all EV charging points while meeting the charging requirements of EV Users.

### “MY COMMUNITY” Feature in the App

This is where the Network and System will bring the EV community together by providing a host of services including:
EV Chat room (Talk to other EV car owners)
Government updates (regional)
EV News and Reviews

### “MY SHOP” Function in the App

This incorporates all things EV giving a shop window to the EV user to compare prices and reviews of EV related goods and services as well as enable purchasing all EV related items, such as:
Insurance. (Preferable community rates)
Car loans and financing.
Car servicing and repair.
Home charging units and installation.
Battery rental
Voucher rewards
Membership points redemption.
Charity support, giving back to our communities.

### “MEMBERSHIP POINTS” Function in the App

The whole community platform is underpinned by a points system or rewards scheme based on usage by the EV User member in the EV Users Network and System. Such points are earned by members from purchase of EV power or purchases of goods and services within the EV Users Network. The points can be redeemed through the EV Businesses in the EV Users Network or used to receive free charges or services. The points will be shown in a member's account in a real-time basis. Such management and administration of a points system or rewards scheme is known and its structure would only be discussed briefly herein. The membership structure would also cover a few levels from basic membership to full membership (as an EV User) or as an EV Business Partner as in the case of an EV retailer or EV Service Provider.

### Illustration of How an EV User Uses the Mobile App in Looking for a Charging Point

A brief description of how an EV User would use the Mobile Phone to access the EV Users Network System (100) to use some features and functions would be given herein.

If an EV User finds that the battery of the EV is reaching a low level and has to be re-charged, the EV User would access his Mobile Phone. Firstly he would enter his user ID and password to log on and have access to the EV Users Network and System.

The EV User would go to the “LOCATE & CHARGE” function in the App,

The EV User notes the locations of all EV Chargers nearby. These EV chargers may be operated by Petrol Stations or independent operators or by EV sharing operators as part of the EV Power Grid (20). The EV owner may carry out price comparisons of these available chargers using the Price Comparison feature in the Mobile App. If the EV owner decides on a EV Charging location, he would use the Book My Charge Time Slot function. In addition the EV Owner would use Plan my Trip feature to drive to the Charging location in the shortest possible time.

The EV User then parks the EV and having connected the EV to the Charging Point (21), confirms that the charging is to proceed. Since the Charging Point is booked using the EV Users Network System (100), all communications on charging using the selected Charging Point would be with the Charging Network provider, through the EV Users Network System. When the charging is completed, the Charging Network provider would send a message to the EV User that the charging of his EV is completed and he has to vacate the Charging Point. The EV User would then drive the EV away, and log out of the Charging Network used. The EV User may also check his Account (in the EV Users Network System) to see the amount charged to his account for charging his EV. The EV user may note that his credit balance in his account with the EV Users Network is getting low and he may have to “top up” the credit balance in his account. He may carry out an electronic bank transfer (using another banking App in his Mobile Phone for this purpose.) He may also request the EV User Network to produce a statement of transactions in the EV Users Network System. He may see details of his purchases of goods and services from other EV businesses providing EV related goods and services in the same period. Finally the EV User may also instruct the App to download the same statement in the form of an electronic file, for his records.

### EV Users Application on Other Electronic Devices

The features and functions of the EV Users Network System as described in the Mobile App would also be seen and used, in the same manner as in the Mobile App, on other electronic devices such as Personal Computer, Tablet or even the computer in the EV (10).

As such the workings of these features/functions in other electronic devices would not be repeated herein.

### The EV Users Network System (100)

These are some main features (not exhaustive) of the EV Users Network System:

### Single Authorisation and Authentication System

The authentication and authorisation system allows for users to access data and provide specific rights of access to different parts and different parties in the EV Users Network System.

### Interface Modules

Since EV Users, EV Charging Networks (21) and EV Businesses (103) may already be connected electronically to their own (internal) systems, various Interface Modules may be required to enable data to be exchanged across various operating platforms. Interface Modules would handle this efficiently so that EV Users can efficiently exchange communications and carry out transactions such as booking a Charging Point or make a purchase from an EV related business smoothly.

### EV Businesses Information Portal

EV Users may receive notification on new products, reference information on the new products and all goods available for sale, promotions from EV businesses

### EV Owners Information Portal

EV Users may be able to exchange messages and chat with each other through this Portal, thus enabling all EV owners to receive notification and updates on EV related matters. This community aspect of the EV Users Network would address all the daily EV information needs and provide full support to EV Users who are members of this network. Included in this category would be 24 hour support for all EV questions, advice on repair and location and advice on maintenance and handling of EVs.

EV owners may also be able to request or book for services offered by the EV Users Network System (either by the Platform operator or through their appointed agents) such as:
24 hour emergency mobile call out emergency charge service;
Drive me home service;
24 hour car recovery service;

all of which would enable the EV User to have peace of mind should either their EV breaks down or the EV User is not able to drive the EV.

### EV Businesses Portal

Businesses of EV goods and services may have their own sub-system already. Interface module would enable their sub-systems to be connected electronically to the EV Users Network. Therefore EV Users would be able to access the portals or websites of these businesses to carry out transactions and make payments directly.

### EV Shop and Rewards

This would enable EV Users to receive points for charging each EV or for purchase of goods and services from any EV related business and redeem these points to get shopping discounts, partner rewards, or other goods and services.

### System of Communication for All Users

This would include notifications from system administrators, direct communication with vendors, industrial chat groups and forums. The System Operator may also prepare and circulate different circulars and newsletters for different groups within the EV Users Network, for example, newsletters to providers/businesses of EV related goods and services may be business in nature while newsletters to EV users may be more on new EVs and educational in nature.

### On-Line Learning System

Users would have access to educational videos and educational materials related to EVs, as well as read articles and reviews on test drives of EVs and information on EV batteries.

### Payment Systems

Users may have payments made to them to top up their mobile phone account balances or to other payment systems such as payment cards or credit card or bank account. Links to financial payment institutions would have to be included. Since links to bank accounts or credit cards/debit cards are involved, the system would include anti-fraud checks and authentication measures.

### Internal Billing System.

This allow users to view vendor's balances, balance top up, request and produce financial reports, which are commonly available.

### Statistics and Analytics System

Users may view statistics on their account, points earned, application usage and special alerts. Users would also review charging volume, running costs of the EV, costs of repair and service, annual running costs and even annual carbon credit.

### Rating System

This allow users to see ratings and feedback for retailers or reports on new EVs and new products related to EVs.

### EV Users Network System (100)

The Users Network System would be managed and operated by a System Manager/Operator, and responsible for smooth management of all EV Users and EV related businesses. Since different sub-systems are used by different parties, the System would have Interface Modules for the smooth exchange of electronic data between all parties in the System. The System Manager/Operator would also manages all users assigning them access to different functions/modules within the EV User Network System for smooth interaction and communications.

The System would include servers and Cloud networks are known in the art and as such, these details and their operations would not be discussed in detail herein.

### ADVANTAGEOUS EFFECTS OF THE INVENTION

The present invention provides an EV Users Network a one-stop network which offers information for all EV users and EV operational needs. By harnessing all EV Charging points (whether independently managed or managed as part of an EV charging network (21), the invention would allow convenience to EV users and optimal utilization of EV Charging resources. The EV Users Network System would meet gaps on EV information enabling EV Users to obtain advice on how EVs work differently from gas and diesel powered cars to information on how to handle breakdowns of EVs. The network would also bring all EV Users and providers of EV related products and services (10) into a community.

1. An electric vehicle (EV) user network system (100) having a dedicated server (110) and a cloud server (120) for connecting EV owners and users, EV charging stations and EV charging networks, and EV related businesses into an EV User Network, comprising:
(i) an EV Power Grid of charging stations and charging network (20);
(ii) a One-Stop Shop connecting all EV related businesses in the network (40);
(iii) a technical support & services network (70),
(iv) an Account for each user (50) connecting the user to the EV Power Grid, One Stop Shop and the technical support & services network; and
(v) all the users and EV related businesses connected and communicating with each other in a community network for dissemination and education of EVs and EV related matters (60);
wherein the EV user network system connects the EV Power Grid of charging stations and charging network (20), the One-Stop Shop (40), all Account Users (50), EV related businesses connected and communicating through the community network (60), and to the technical support and services network in real-time, enabling real-time access using a mobile phone or personal computer or the like; and
wherein the EV user network system provides a number of services to EV owners or users as members of the EV user network, each member draws down points for usage of services in a subscription base model, services including charging for charging of EV and purchase of goods and services from EV related businesses and provision of technical support and other services provided by the EV user network (100).

2. The EV user network system (100) having a dedicated server (110) and a cloud server (120) as set forth in claim 1, wherein the support from the EV User Network includes
(i) price comparisons on available charges;
(ii) topping up account of the members;
(iii) providing services that no other charge point operators provide together with a host of additional benefits;
(iv) establishing a network for all members in the EV user network as a community;
(v) incorporating all EV related businesses offering goods and services related to EVs; and providing a point system or rewards scheme based on usage, purchases of goods and services from within the EV user network system.

3. The EV user network system (100) having a dedicated server (110) and a cloud server (120) as set forth in claim 2, wherein the host of additional benefits include (i) mobile charge call out service, (ii) recover my car service, (iii) drive me home service, and my mechanic online.

4. The EV user network system (100) having a dedicated server (110) and a cloud server (120) as set forth in claim 2 or 3, wherein the services and benefits are provided around the clock.

5. The EV user network system (100) having a dedicated server (110) and a cloud server (120) as set forth in claim 2, wherein the members of the community are able to view their respective account designated as Flex e Account.

6. The EV user network system (100) having a dedicated server (110) and a cloud server (120) as set forth in claim 2, wherein the goods and services offered by EV businesses including:
(i) purchase of EV insurance;
(ii) car loans and financing;
(iii) car servicing and repairing;
(iv) home charging units and installation;
(v) battery rental;
(vi) voucher rewards;
(vii) members points redemption, and
(viii) charity support such as giving back to communities or other charitable institutions.

7. The EV user network system (100) having a dedicated server (110) and a cloud server (120) as set forth in claim 1, wherein the EV charging network (20) provides the function of (i) locating and booking an EV charger, (ii) EV charging price comparison, and (iii) trip planning with EV charging in mind, including available socket type, compatibility of connector and charging output.

8. The EV user network system (100) having a dedicated server (110) and a cloud server (120) as set forth in claim 1; wherein the technical support & services network (70) offers services including:
(i) technical support/advice via live chat;
(ii) mobile charge call-out service;
(iii) car recovery service; and
(iv) drive-me-home service.

9. The EV user network system (100) having a dedicated server (110) and a cloud server (120) as set forth in claim 1, wherein the one stop shop connects the users to EV related businesses to obtain goods and services including
(i) managing car insurance, loans, financing and the like;
(ii) arranging for EV maintenance, repair, battery rental;
(iii) arranging for home charging unit installation and repairs; and
(iv) purchasing EV-related items with price comparisons.

10. The EV user network system (100) having a dedicated server (110) and a cloud server (120) as set forth in claim 1, wherein the Account (50) of each User allow points to be earned for the Account by the EV User:
(i) charging each EV or obtaining goods and services from any EV related business;
(ii) using points to get shopping discounts, partner rewards, or free goods and services;
(iii) reviewing past transactions; and
(iv) reviewing membership details and account information.

11. The EV user network system (100) having a dedicated server (110) and a cloud server (120) as set forth in claim 1, wherein the members in the community network (60) may (i) communicate with each other in chat rooms about EVs, (ii) access EV related news and updates, and (iii) access EV reviews.

12. The EV user network system (100) having a dedicated server (110) and a cloud server (120) as set forth in claim 11, wherein the access to EV related news and updates and access to use of EV charging networks and charging points are by way of a Mobile Phone app.

13. The EV user network system (100) having a dedicated server (110) and a cloud server (120) as set forth in claim 11, wherein the access to EV related news and updates and access to use of EV charging networks and charging points are by way of a Personal Computer or a Laptop or Tablet.

14. The EV user network system (100) having a dedicated server (110) and a cloud server (120) as set forth in claim 11, wherein the access to the EV related news and updates and access to use of EV charging networks and charging points is by any electronic computing device with Internet access installed in an EV.

15. A method to connect an EV User to an EV user network system (100) having a dedicated server (110) and a cloud server (120) with EV owners and users, EV charging stations and EV charging networks, and EV related businesses, using a Mobile App to search for a charging point to charge an EV, the method comprising the steps of:
(i) logging in to the EV user Account with user ID and password to access to the EV user network;
(ii) clicking onto “LOCATE & CHARGE” function in the Mobile App;
(iii) selecting a location of all EV chargers indicated by the Mobile App in step (ii);
(iv) carrying out price comparison for all EV chargers in the said location;
(v) using “Book My Charge” function to reserve a time slot for charging; and
(vi) employing “Plan My Trip” function to drive to the selected charging location.

16. The method to connect an EV user to an EV User network System using a Mobile App to search for a charging point to charge an EV as set forth in claim 15, wherein the EV chargers are operated by Petrol Stations or by EV sharing operators or by an independent operator of EV chargers as part of a EV Power Grid in the EV User Network System.

17. The method to connect an EV user to an EV User Network System using a Mobile App to search for a charging point to charge an EV as set forth in claim 15, wherein all communications on charging by the EV user is linked to a charging Network provider via the EV Power Grid in the EV user network system, and the changing network provider will send a message to the EV user that the charging process is completed.

18. The method to connect an EV user to an EV User Network System using a Mobile App to search for a charging point as set forth in claim 17, wherein a message is sent to the EV owner by the charging network provider upon the completion of the charging process, and the EV owner drives away the EV and logs out of the Charging network and EV Power Grid.

19. The method to connect an EV user to an EV User Network System using a Mobile App to search for a charging point as set forth in claim 15, wherein the EV user can check an Account of the EV user on the credit balance in the Account to ensure the credit balance of the Account is correct, and to perform a “top up” in the Account.

20. The method to connect an EV user to an EV User Network System (100) using a Mobile App to search for a charging point as set forth in claim 19, wherein an electronic bank transfer from a bank account of the EV User is made to perform the “top-up” to the Account of the User by using the Mobile Phone.

21. The method to connect an EV user to an EV User network system (100) using a Mobile App to search for a charging point as set forth in claim 15, wherein a Personal Computer and/or a Tablet or any electronic computing device installed in the EV is used by the EV user to perform the method to search for a charging point for the EV.

22. The EV user network system (100) as set forth in claim 1, further comprising:
(vi) a single authorisation and authentication allowing the user to access data and provide specific rights of access to different parties in the EV user network.

23. The EV user network system (100) as set forth in claim 1, further comprising
(vii) a plurality of interface modules enabling data to be exchanged across various operating platforms and systems.

24. The EV user network system (100) as set forth in claim 1, further comprising an EV Businesses Information Portal which allows EV users to receive notification on new products, reference information on the new products and all goods available for sales and promotions from EV businesses.

25. The EV user network system (100) as set forth in claim 1, further comprising an EV owners Information portal which allows the EV user to exchange messages and chat with each other through the EV owner information portal, thus, enabling all EV owners to receive notification and updates on EV related matters.

26. The EV Businesses Information Portal in the EV user network system (100) as set forth in claim 24, wherein the notification on new products include links to a plurality of EV models.

27. The EV user network system (100) as set forth in claim 1, further comprising an enterprise network (10) which includes a plurality of service providers such as EV Service/Repair/Maintenance (101), bank/financial institutions (102), and EV-related Businesses (103).

28. The EV user network system (100) as set forth in claim 27, wherein the enterprise network provides services including 24-hour emergency mobile call out, emergency charge service, drive me home service, and 24-hour car recovery service.

29. The EV user network system (100) as set forth in claim 1, wherein a system manager/operator manages and operates the EV user network (100) and is responsible for smooth management of all EV user and EV related businesses in the system in the network.

30. The EV user network system (100) as set forth in claim 1, wherein the system manager/operator prepares and circulates different circulars and newsletters for different groups of users with different interests within the EV user network.

31. The EV user network system (100) as set forth in claim 1, wherein the system manager/operator allows an EV user to open an Account (50) to join as a member on a subscription based model in order to have membership privileges, including access to the User Network to:
(i) obtain points by charging or making purchases for goods and services from EV related businesses and for charging the EV;
(ii) use the points to get shop discounts, partner rewards or free goods and services;
(iii) review past transactions by the EV user; and
(iv) review membership details and information.

32. The EV user network system (100) as set forth in claim 1, wherein the system manager/operator allows an EV related business upon joining the EV User Network to open an Account (50) to join as a business partner member in order to be able to offer EV related goods and services to other users in the User Network, including:
(i) offer goods and services to and receive payment from Users in the Users Network including services for charging the EV;
(ii) offer discounts, partner rewards or free goods and services;
(iii) reviews transactions by the EV related businesses; and
(iv) circulate EV related information to EV users.

33. The EV user network system (100) as set forth in claim 1, wherein the EV user is able to access an On-line learning system related to EVs and reviews on test drives of EVs and information on EV batteries.
